(19) United States
(12) Patent Application Publication
(10) Pub. No.: US 2013/0314905 A1
(43) Pub. Date: Nov. 28, 2013

(54) ILLUMINATING DEVICE FOR BALLOON

(71) Applicant: Jerry S. C. Yang, Taichung (TW)

(72) Inventor: Jerry S. C. Yang, Taichung (TW)

(21) Appl. No.: 13/478,119

(22) Filed: May 23, 2012

(51) Int. Cl. F21V 33/00

(52) U.S. Cl. 362/109

(57) ABSTRACT

An illuminating device for a balloon includes a hand-held cylinder, an illuminating module, a lampshade, a battery unit and a balloon cover. The hand-held cylinder has a fixing portion at a front end thereof for mounting the balloon. The illuminating module and the lampshade are coupled to the front end of the hand-held cylinder. The battery unit is disposed in the hand-held cylinder. The balloon cover has a bowl-shaped wall. The bowl-shaped wall has a connection opening at one end thereof and a front opening at another opposing end thereof. The connection opening is adapted to connect the front end of the hand-held cylinder. The front opening is adapted to receive the balloon. The balloon is connected to the fixing portion of the hand-held cylinder. The balloon cover is used to protect the balloon. The illuminating module is used to illuminate the balloon.

### BACKGROUND OF THE INVENTION

(a) Field of the Invention

The present invention relates to an illuminating device for a balloon, and more particularly to an illuminating device to illuminate a balloon fixed at the front end of the illuminating device so that the balloon has an illuminating effect.

(b) Description of the Prior Art

Conventional illuminating devices are often used for decorative illumination. For a celebration, performance, party, birthday party, or the like, people often decorate the site with decorative lamps and balloons. Only the decorative lamps have an illuminating effect. The balloons don't have an illuminating effect. It is a troublesome job to decorate the site with lamps and balloons. Therefore, some illuminating devices are developed, see e.g. U.S. Pat. No. 7,699,505 titled “Balloon Lamp”, U.S. Pat. No. 5,117,344 titled “Colored Balloon”, U.S. Pat. No. 5,295,891 titled “Balloon Holding Device”, U.S. Pat. No. 7,344,267 titled “Balloon Colored Toy”, U.S. Pat. No. 7,364,488 titled “Illuminating Balloon”.

The user cannot hold the illuminating devices disclosed in the aforesaid patents to swing the illuminating balloons, so the illuminating devices cannot be adapted for a celebration, performance, party, birthday party, or the like. The inventor of the present invention has invented a balloon lamp disclosed in U.S. Pat. No. 7,699,505 and Taiwanese Patent No. I338104. It is not easy and convenient to mount the balloon on the lamp, so it's troublesome to install the balloon. Besides, the lamp doesn't have a structure to protect the balloon and the user's hand. Without a separation structure, the balloon may burst to scare the user.

Accordingly, the present invention is intended to provide an illuminating device for a balloon to overcome the shortcomings mentioned above.

### SUMMARY OF THE INVENTION

The primary object of the present invention is to provide an illuminating device for a balloon. The user can conveniently tie the balloon on the illuminating device. The light from the illuminating device shines on the balloon so that the balloon has an illuminating effect. The user can hold the illuminating device with the illuminating balloon for a celebration, performance, party, birthday party, or the like to create a special vision effect. Through the design of the illuminating device, the balloon can be protected by a balloon cover.

In order to achieve the aforesaid object, the illuminating device for a balloon of the present invention comprises a hand-held cylinder, an illuminating module, a lampshade, a battery unit and a balloon cover. The hand-held cylinder comprises a cylinder body and an end cap. The cylinder body has a fixing portion at a front end thereof for mounting the balloon. The cylinder body has an accommodation chamber at the front end thereof and a battery trough at a rear end thereof. The accommodation chamber communicates with the battery trough. The end cap is connected to the rear end of the cylinder body. The illuminating module comprises a circuit board and at least one illuminating member mounted on the circuit board. One side opposite to the illuminating member of the circuit board is provided with a first electrode. The illuminating member is a light emitting diode. The circuit board of the illuminating module is disposed in the accommodation chamber of the cylinder body. The first electrode faces the battery trough. The lampshade is connected to the front end of the cylinder body of the hand-held cylinder to cover the illuminating module. The battery unit is disposed in the battery trough of the cylinder body and contacts with the first electrode of the illuminating module. The balloon cover has a bowl-shaped wall. The bowl-shaped wall has a connection opening at one end thereof and a front opening at an opposing end thereof. The connection opening is adapted to connect with the front end of the cylinder body. The front opening has a diameter larger than that of the connection opening.

The illuminating device of the present invention is provided for the user to tie the inflated balloon on the fixing portion at the front end of the hand-held cylinder. The balloon cover is fitted on the front end of the hand-held cylinder to hold the balloon in place and to protect the balloon and the user's hand. When the user turns on the illuminating module to illuminate the balloon, the balloon will have an illuminating effect. The present invention can be used for a celebration, performance, party, birthday party, courtyard decoration, or the like.

### BRIEF DESCRIPTION OF THE DRAWINGS

FIG. 1 is a sectional view of the illuminating device for balloon according to a preferred embodiment of the present invention;

FIG. 2 is a top view of the illuminating device for balloon according to the preferred embodiment of the present invention;

FIG. 3 is an exploded view of the illuminating device for balloon according to the preferred embodiment of the present invention;

FIG. 4 is a perspective view of the illuminating device for balloon according to the preferred embodiment of the present invention;

FIG. 5 is a side view of the illuminating device for balloon according to the preferred embodiment of the present invention;

FIG. 6 is a schematic view showing the mounting of the balloon of the preferred embodiment of the present invention; and

FIG. 7 is a schematic view of the preferred embodiment of the present invention when in use.

### DETAILED DESCRIPTION OF THE PREFERRED EMBODIMENTS

Embodiments of the illuminating device for balloon according to the present invention will now be described, by way of example only, with reference to the accompanying drawings.

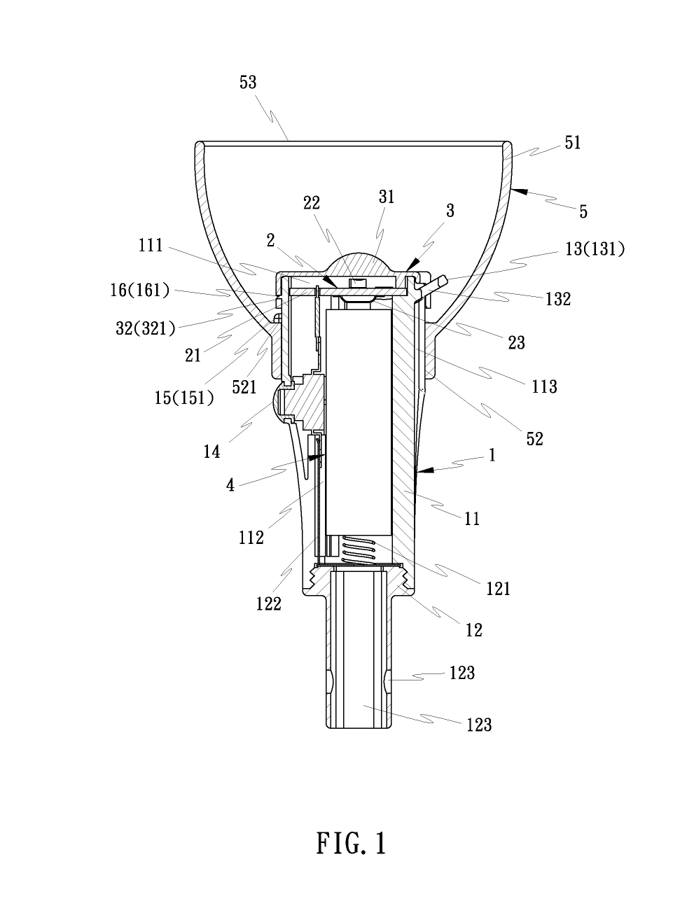

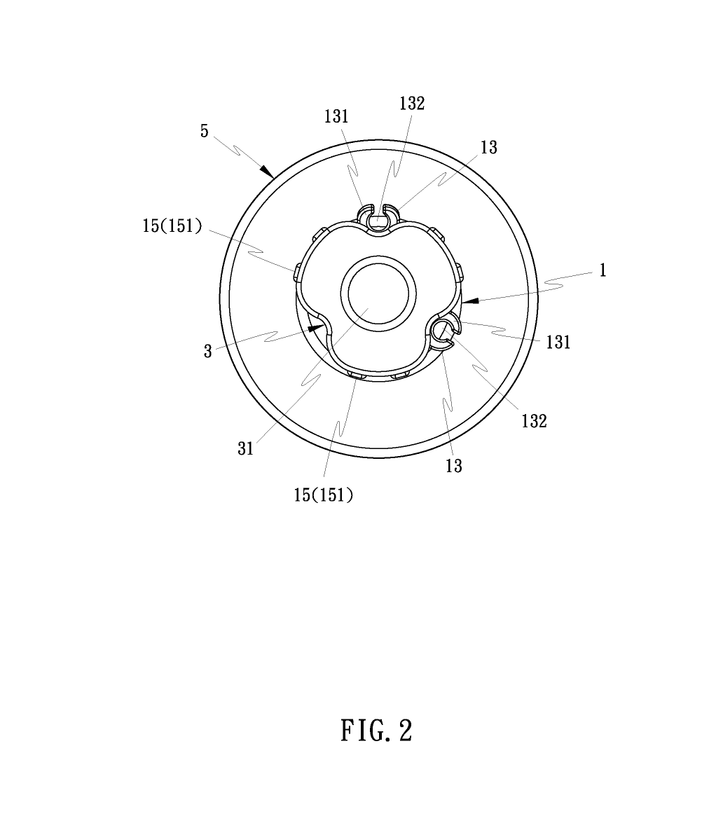

As shown in FIG. 1 through FIG. 4, the illuminating device for a balloon according to a preferred embodiment of the present invention comprises a hand-held cylinder 1, an illuminating module 2, a lampshade 3, a battery unit 4, and a balloon cover 5.

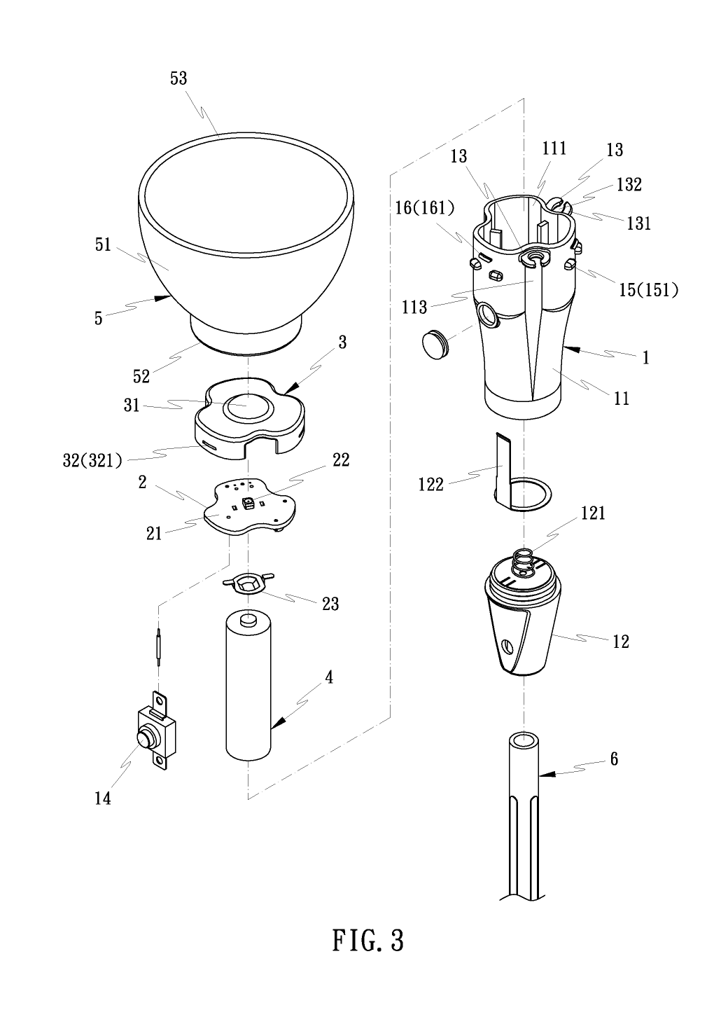

The hand-held cylinder 1, as shown in FIG. 1 and FIG. 3, comprises a cylinder body 11 and an end cap 12. The cylinder body 11 is a hollow cylinder, and has a fixing portion 13 at a front end thereof for mounting a balloon. The fixing portion 13 is a protruding plate 131. The protruding plate 13 has a notch 132 for tying or engagement of the balloon. The cylinder body 11 has an accommodation chamber 111 at the front end thereof and a battery trough 112 at a rear end thereof. The accommodation chamber 111 communicates with the battery trough 112. The end cap 12 is threadedly connected to the rear end of the cylinder body 11. The end cap 12 is provided with a second electrode 121 and a conductive member 122. The end cap 12 can be opened for replacement of the battery in the battery trough 112 of the cylinder body 11.

The illuminating module 2, as shown in FIG. 1 and FIG. 3, comprises a circuit board 21, at least one illuminating member 22 mounted on one side of the circuit board 21, and other required control circuit. Another side opposite to the illuminating member 22 of the circuit board 21 is provided with a first electrode 23. The first electrode 23 is adapted to contact with the battery unit 4. The circuit board 21 of the illuminating module 2 is disposed in the accommodation chamber 111 of the cylinder body 11. The first electrode 23 faces the battery trough 112, and the illuminating member 22 faces the front end of the cylinder body 11. Preferably, the illuminating member 22 is a light emitting diode which can change the color of light.

The lampshade 3, as shown in FIG. 1 and FIG. 3, is a light-pervious cover connected to the front end of the cylinder body 11 of the hand-held cylinder 1 to cover the illuminating module 2. The light from the illuminating member 22 can transmit through the lampshade 3. The lampshade 3 has an optical portion 31 which protrudes from the center of the front end of the lampshade 3 and is used to refract the light. The optical portion 31 is convex.

The battery unit 4, as shown in FIG. 1 and FIG. 3, can be a dry battery or a rechargeable battery. The battery unit 4 is disposed in the battery trough 112 of the cylinder body 11 and contacts with the first electrode 23 of the illuminating module 2 to supply power to the illuminating module 2.

The balloon cover 5, as shown in FIG. 1 and FIG. 3, is made of a soft plastic material and has a bowl-shaped wall 51. The bowl-shaped wall 51 has a connection opening 52 at one end thereof and a front opening 53 at an opposing end thereof. The connection opening 52 is adapted to connect the front end of the cylinder body 11. The front opening 53 has a diameter larger than that of the connection opening 52 so as to receive the balloon therein.

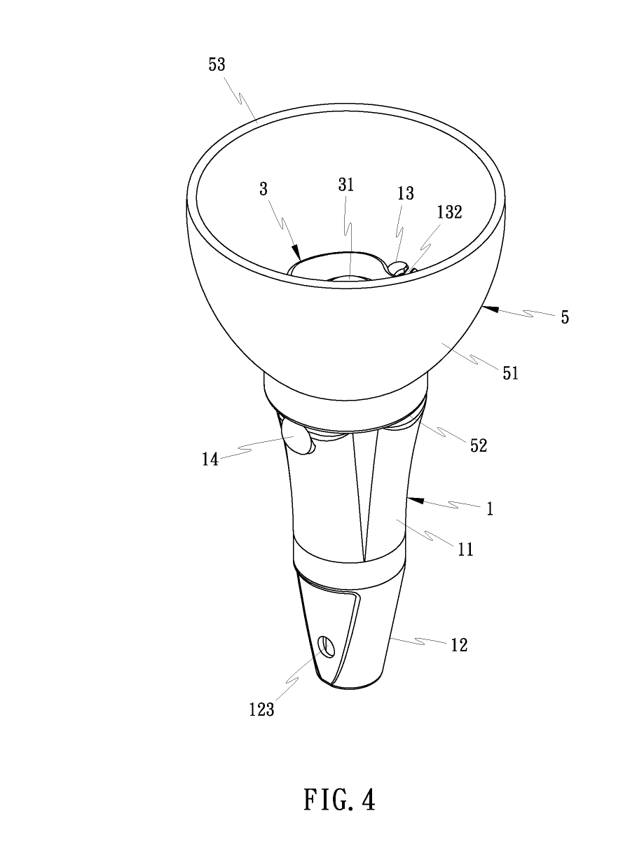

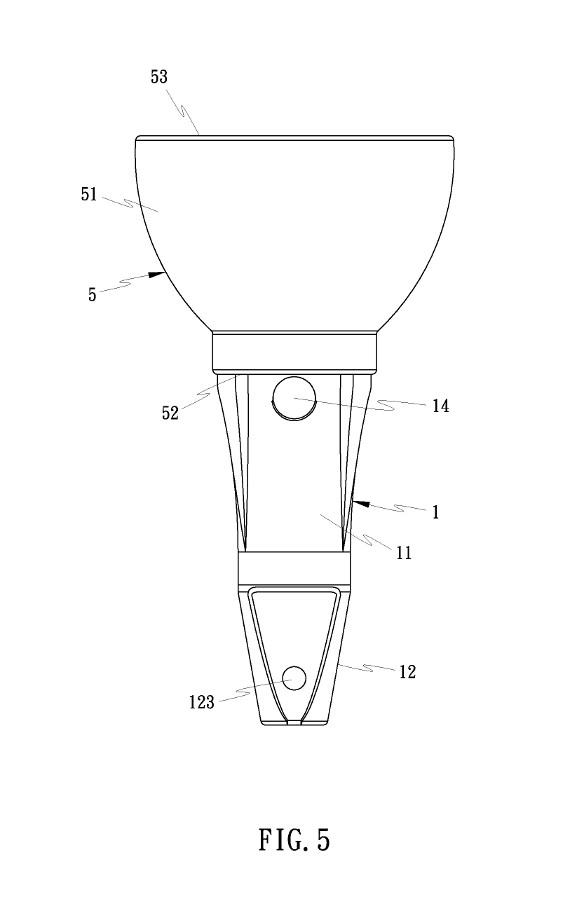

The hand-held cylinder 1, the illuminating module 2, the lampshade 3, the battery unit 4 and the balloon cover 5, as shown in FIG. 1, FIG. 4 and FIG. 5, are assembled to complete the illuminating device for a balloon of the present invention. The balloon can be mounted at the front end of the hand-held cylinder 1. The light from the illuminating module 2 can emit to the balloon so that the balloon appears illuminating.

Referring to FIG. 1 and FIG. 3, one side of the cylinder body 11 of the present invention is formed with at least one concave portion 113. The fixing portion 13 is disposed in the concave portion 113 so that the fixing portion 13 won't interfere with the bowl-shaped wall 51 of the balloon cover 5. Furthermore, the cylinder body 11 has at least one engaging portion 15 close to the front end of the cylinder body 11. The engaging portion 15 is a protruding block 151 protruding from the side wall of the cylinder body 11. The balloon cover 5 is made of a soft plastic or rubber material. The balloon cover 5 has a stop portion 521 on the inner wall of the connection opening 52 to engage with the engaging portion 15 (the protruding block 151). Thus, the balloon cover 5 is fitted on the cylinder body 11 and the stop portion 521 engages with the engaging portion 15 (the protruding block 151). The balloon cover 5 can be disconnected from the cylinder body 11.

Referring to FIG. 1 and FIG. 3, the cylinder body 11 of the hand-held cylinder 1 has a plurality of first coupling portions 16 disposed around the front end of the cylinder body 11. The first coupling portion 16 can be a protruding block 161. The lampshade 3 has second coupling portions 32 on a side wall thereof to engage with the first coupling portions 16 of the cylinder body 11. The second coupling portion 32 is a hole 321. When the lampshade 3 is coupled to the front end of the cylinder body 11, the second coupling portions 32 of the lampshade 3 will engage with the first coupling portions 16 of the cylinder body 11. The lampshade 3 can be coupled to the cylinder body 11 quickly and easily.

Referring to FIG. 1 and FIG. 3, one side of the cylinder body 11 of the hand-held cylinder 1 is provided with a power switch 14. The power switch 14 is connected with the circuit board 21 of the illuminating module 2. The power switch 14 can be a press-type switch or a push-type switch, which is adapted to turn on/off the illuminating device. The arrangement of the power switch 14 is not limited to the aforesaid. Fore example. the power switch 14 can alternatively be disposed on the end cap 12. By pressing or pushing or turning the end cap 12, the illuminating device of the present invention is turned on/off.

As shown in FIG. 1, for the illuminating device of the present invention to be placed upright, the end cap 12 of the hand-held cylinder 1 further has a receiving hole 123 for insertion of a rod 6. The receiving hole 123 can be disposed at the bottom or one side of the end cap 12. When it is necessary to position the illuminating device of the present invention in place, the receiving hole 123 is adapted to receive the rod 6.

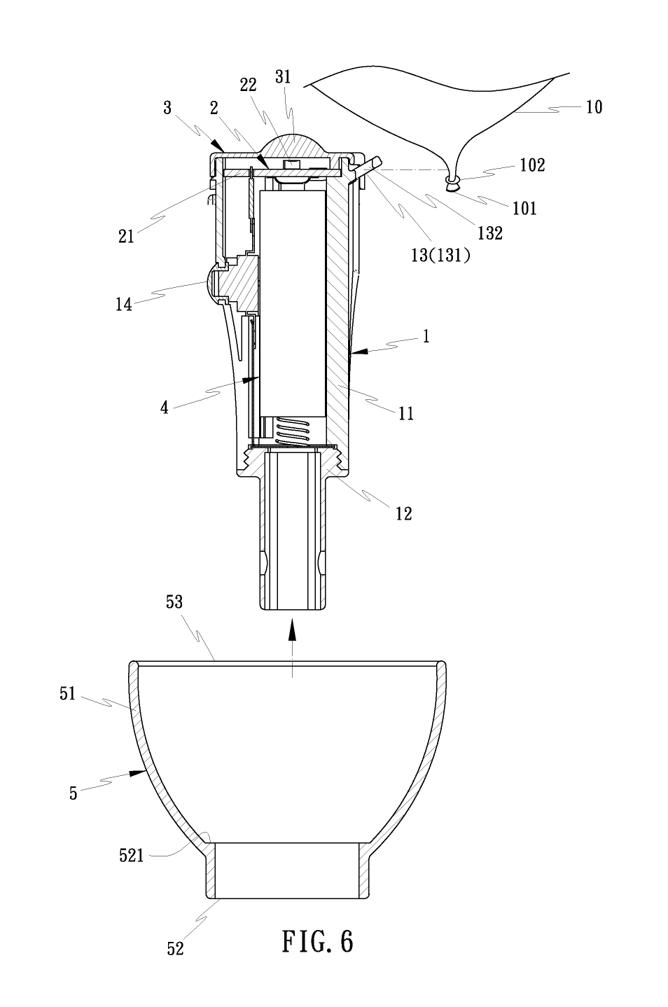

Referring to FIG. 6, when in use, the balloon 10 is inflated, and then the nozzle 101 of the balloon 10 is tied with a knot 102. After that, the nozzle 101 is inserted into the notch 132 of the fixing portion 131 of the hand-held cylinder 1 and the knot 102 is engaged under the protruding plate 131, so that the balloon 10 is located at the front end of the hand-held cylinder 1. The balloon cover 5 is fitted from the rear end to the front end of the hand-held cylinder 1 with the stop portion 521 at the connection opening 52 to engage with the stop portion 15 (the protruding block 151) of the cylinder body 11. The balloon cover 5 covers the bottom of the balloon 10. Through the balloon cover 5, the balloon 10 and the user's hand can be protected when the user holds the hand-held cylinder 1.

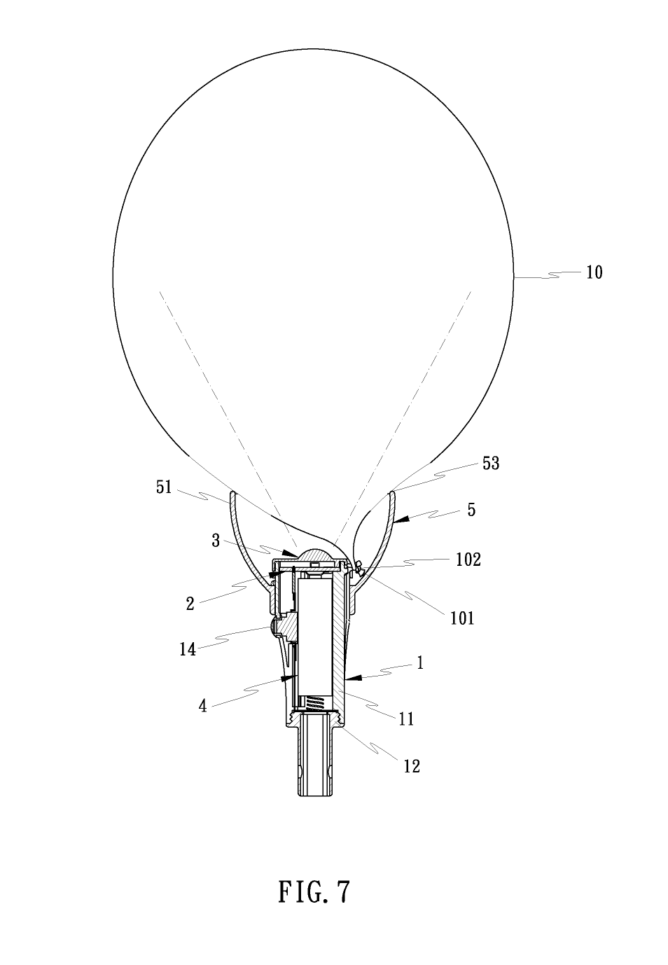

Referring to FIG. 7, when the balloon 10 is coupled to the front end of the hand-held cylinder 1, the user can control the illuminating member 22 through the power switch 14. The illuminating member 22 illuminates the balloon 10 through the optical portion 31 of the lampshade 3. The light from the illuminating member 22 can be refracted and diffused to illuminate the balloon 10.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An illuminating device for a balloon, comprising a hand-held cylinder, an illuminating module, a lampshade, a battery unit and a balloon cover, wherein
the hand-held cylinder comprises a cylinder body and an end cap, the cylinder body having a fixing portion at a front end thereof for mounting the balloon, an accommodation chamber at the front end thereof, and a battery trough at a rear end thereof, the accommodation chamber communicating with the battery trough, the end cap being connected to the rear end of the cylinder body and having a second electrode and a conductive member corresponding to the battery unit;
the illuminating module comprises a circuit board and at least one illuminating member mounted on the circuit board, one side opposite to the illuminating member of the circuit board being provided with a first electrode, the illuminating member being a light emitting diode, the circuit board of the illuminating module being disposed in the accommodation chamber of the cylinder body, the first electrode facing the battery trough;
the lampshade is connected to the front end of the cylinder body of the hand-held cylinder to cover the illuminating module;
the battery unit is disposed in the battery trough of the cylinder body and in contact with the first electrode of the illuminating module; and
the balloon cover has a bowl-shaped wall, the bowl-shaped wall having a connection opening at one end thereof and a front opening at an opposing end thereof, the connection opening being adapted to connect with the front end of the cylinder body, the front opening having a diameter larger than that of the connection opening.

2. The illuminating device for a balloon as claimed in claim 1, wherein the fixing portion is a protruding plate, and the protruding plate has a notch for tying the balloon.

3. The illuminating device for a balloon as claimed in claim 2, wherein one side of the cylinder body is formed with at least one concave portion, and the fixing portion is disposed in the concave portion.

4. The illuminating device for a balloon as claimed in claim 1, wherein the cylinder body of the hand-held cylinder has a first coupling portion close to the front end of the cylinder body, and the lampshade has a second coupling portion on a side wall thereof to engage with the first coupling portion of the cylinder body.

5. The illuminating device for a balloon as claimed in claim 1, wherein the cylinder body has at least one engaging portion close to the front end of the cylinder body, and the connection opening of the balloon cover is engaged with the engaging portion of the cylinder body.

6. The illuminating device for a balloon as claimed in claim 5, wherein the engaging portion of the cylinder body is a protruding block protruding from a side wall of the cylinder body.

7. The illuminating device for a balloon as claimed in claim 6, wherein the balloon cover has a stop portion on an inner wall of the connection opening to engage with the engaging portion of the cylinder body.

8. The illuminating device for a balloon as claimed in claim 7, wherein the balloon cover is made of a soft plastic material.

9. The illuminating device for a balloon as claimed in claim 1, wherein one side of the cylinder body of the hand-held cylinder is provided with a power switch which is connected with the circuit board.

10. The illuminating device for a balloon as claimed in claim 9, wherein the power switch is a press-type switch or a push-type switch.

11. The illuminating device for a balloon as claimed in claim 1, wherein the end cap of the hand-held cylinder further has a receiving hole for insertion of a rod.

12. The illuminating device for a balloon as claimed in claim 1, wherein the lampshade has a convex optical portion protruding from a front end thereof for refracting light from the illuminating member.
